(19) United States
(12) Patent Application Publication
(10) Pub. No.: US 2012/0006207 A1
(43) Pub. Date: Jan. 12, 2012

(54) COOKING DEVICE

(76) Inventor: Hideo Shimoda, Osaka (JP)

(21) Appl. No.: 13/257,729

(22) PCT Filed: Mar. 29, 2010
(86) PCT No.: PCT/JP2010/055555

§ 371 Date: Sep. 20, 2011

(30) Foreign Application Priority Data
Mar. 30, 2009 (JP) 2009-081282

(51) Int. Cl. A47J 27/04

(52) U.S. Cl. 99/357

(57) ABSTRACT

A cooking device includes a dew receiving container (30) which is removably attached to a main body casing (1) on a lower side and a front surface side of the main body casing (1); and a retention member (40) provided in the main body casing (1) on the lower side and the front surface side of the main body casing (1), to hold the dew receiving container (30). The retention member (40) includes a drainage channel which is positioned above a dew receiving recessed portion of the dew receiving container and receives water droplets dropping along the front surface of the main body casing, and a drainage hole through which the water droplets received by the drainage channel is introduced to the dew receiving recessed portion. A downwardly tapered rib (56) is provided in vicinity of an edge of the opening of the drainage hole (53) of the retention member.

### TECHNICAL FIELD

The present invention relates to a cooking device.

### BACKGROUND ART

Among conventional cooking devices in which heating of a cooking object to be cooked is fulfilled with thermal energy of steam is one which is so designed as to prevent water drips condensed on an inner surface of a door or the like during cooking from dropping onto the floor surface (JP 5-42904 U (Patent Literature 1)). In this cooking device, located below the door for opening and closing a front opening of a heating chamber is a dew receiving container having a receiver opening that extends from the outer surface of the door rearward of the inner surface of the door. This dew receiving container is removably attached to a retention member provided on a lower, front side of a main body casing.

In this cooking device, water drips condensed on the inner surface of the door during cooking fall along the inner surface of the door, partly accumulating between a peripheral wall of the opening of the heating chamber and the inner surface of the door. Then, when the door is opened at a cooking end, accumulated water drips or those attached to the inner surface of the door are allowed to fall into the dew receiving container, thereby prevented from falling onto the kitchen floor surface.

In the cooking device having such a construction as described above, if a structure were adopted that a retention member for holding the dew receiving container on the lower, front side of the main body casing is provided so as to hold on the lower, front side of the main body casing by an upper-side portion of the retention member, the structure would cause water drips, which have dripped along the front face of the main body casing, to be accumulated in an upper-side narrow region of the retention member, and there would be provided a drainage hole for leading that water to the lower dew receiving container. It is noted that this cooking device is only for an easier understanding of this invention, and neither a known art nor a prior art.

However, in such a cooking device as described above in which water drips are accumulated in an upper-side narrow region of the retention member, given that the drainage hole provided in the upper-side portion of the retention member is a circular hole, there is a problem that water drips that have been rounded by surface tension come to be accumulated in the circular hole and so hardly fall into the dew receiving container, inhibiting a smooth drainage.

### CITATION LIST

### Patent Literature

PATENT LITERATURE 1: JP 5-42904 U

### SUMMARY OF INVENTION

### Technical Problem

Accordingly, an object of the present invention is to provide a cooking device in which water drips that have accumulated in the upper-side portion of the retention member for the dew receiving container can be drained smoothly to the lower dew receiving container.

### Solution to Problem

In order to solve the above object, according to the present invention, there is provided a cooking device comprising:

a main body casing;

a heating chamber placed within the main body casing and being for heating a heating object to be heated;

a steam generator placed within the main body casing and being for generating steam to be supplied to the heating chamber;

a door placed on a front side of the main body casing and being for opening and closing an opening of the heating chamber;

a dew receiving container removably attached to a lower, front side of the main body casing; and

a retention member provided on the lower, front side of the main body casing and being for holding the dew receiving container, wherein

the retention member has

a recess portion which is provided on a dew receiving recessed portion of the dew receiving container and which receives drips dripping down along a front face of the main body casing, and

a drainage hole for leading the drips received by the recess portion to the lower dew receiving recessed portion, and

a drip downward-drawing member provided near an opening edge of the drainage hole of the retention member.

With this constitution, the dew receiving container is removably attached by the retention member provided on the lower, front side of the main body casing. Drips dripping down along the front face of the main body casing are received by the recess portion of the retention member provided on the dew receiving recessed portion of the dew receiving container. Then, drips received by the recess portion are led by the drainage hole to the dew receiving recessed portion of the lower dew receiving container. In this process, drips are drawn downward by the drip downward-drawing member provided near the opening edge of the drainage hole of the retention member, so that the drips are led from the drainage hole to the lower dew receiving container. Accordingly, drips accumulated in upper part of the retention member for the dew receiving container can be drained smoothly to the lower dew receiving container.

In one embodiment, the drip downward-drawing member is at least rib- or rod-shaped.

According to this embodiment, by the drip downward-drawing member formed at least into a rib or rod shape, drips are led from the drainage hole along the drip downward-drawing member toward the lower dew receiving container. Thus, drips accumulated in upper part of the retention member can be drained more smoothly to the lower dew receiving container.

In one embodiment, the drainage hole of the retention member has, at an inner edge thereof, an angle defined by straight lines.

It is noted here that the shape of the drainage hole has only to be one having at least one angle defined by straight lines at an inner edge, and the shape is not limited to a rectangular shape or the like.

According to this embodiment, by the shape of the drainage hole of the retention member being set to one having, at an inner edge thereof, an angle of intersecting straight lines, when drips received by the recess portion are led by the drainage hole to the dew receiving recessed portion of the lower dew receiving container, surface tension of the drips is dispersed by the angle (an angle defined by straight lines) of the inner edge of the drainage hole, inhibiting rounding of the drips, so that the drips are prevented from being rounded by surface tension and staying at the drainage hole, and are led from the drainage hole to the lower dew receiving container. Accordingly, drips accumulated in upper part of the retention member for the dew receiving container can be drained more smoothly to the lower dew receiving container.

In one embodiment, the drainage hole of the retention member is formed into a rectangular shape.

According to this embodiment, the drainage hole of the retention member is formed into a rectangular shape, and the angle of intersecting lines is provided at four places of the inner edge of the drainage hole. Thus, water drips can be prevented from being rounded by surface tension more reliably.

In one embodiment, the drip downward-drawing member is formed into a downward-tapered shape.

According to this embodiment, by the drip downward-drawing member formed into a downward-tapered shape, drips led from the drainage hole along the drip downward-drawing member toward the lower dew receiving container are more easily dripped down from the lower end of the drip downward-drawing member to the lower dew receiving container. Thus, it becomes possible to fulfill smooth drainage.

### Advantageous Effects of Invention

As apparent from the above description, according to the cooking device of the invention, it becomes possible to realize a cooking device in which water drips that have accumulated in the upper-side portion of the retention member for the dew receiving container can be drained smoothly to the lower dew receiving container.

### BRIEF DESCRIPTION OF DRAWINGS

FIG. 1 is a front view of a cooking device which is an embodiment of the present invention, as viewed from its front side;

FIG. 2 is a schematic view of a longitudinal section, as viewed from a right side of the cooking device;

FIG. 3 is a plan view showing a state before a dew receiving container is fitted to a left drip receiving guide and a right drip receiving guide in the cooking device;

FIG. 4 is a rear face view of the dew receiving container;

FIG. 5 is a right side face view showing a state before a dew receiving container is fitted to a left drip receiving guide and a right drip receiving guide in the cooking device;

FIG. 6 is a right side face view showing a state in which the dew receiving container is fitted to the left drip receiving guide and the right drip receiving guide in the cooking device;

FIG. 7 is a plan view of the left drip receiving guide;

FIG. 8 is a front view of the left drip receiving guide;

FIG. 9 is a bottom view of the left drip receiving guide;

FIG. 10 is a sectional view of the left drip receiving guide taken along the line X-X shown in FIG. 8;

FIG. 11 is a perspective view of the left drip receiving guide as viewed from a diagonal upward in the front;

FIG. 12 is a plan view of the right drip receiving guide;

FIG. 13 is a front view of the right drip receiving guide;

FIG. 14 is a bottom view of the right drip receiving guide;

FIG. 15 is a sectional view of the right drip receiving guide taken along the line XV-XV shown in FIG. 13;

FIG. 16 is a perspective view of the right drip receiving guide as viewed from a diagonal upward in the front;

FIG. 17A is a perspective view of a drainage hole and a drip downward-drawing member in a first example of another embodiment;

FIG. 17B is a sectional view taken along the line XVIIb-XVIIb of FIG. 17A;

FIG. 17C is a sectional view taken along the line XVIIc-XVIIc of FIG. 17A;

FIG. 18A is a perspective view of a drainage hole and a drip downward-drawing member in a second example;

FIG. 18B is a sectional view taken along the line XVIIIb-XVIIIb of FIG. 18A;

FIG. 18C is a sectional view taken along the line XVIIIc-XVIIIc of FIG. 18A;

FIG. 19A is a perspective view of a drainage hole and a drip downward-drawing member in a third example;

FIG. 19B is a sectional view taken along the line XIXb-XIXb of FIG. 19A;

FIG. 19C is a sectional view taken along the line XIXc-XIXc of FIG. 19A;

### DESCRIPTION OF EMBODIMENTS

Hereinbelow, the cooking device of the present invention will be described in detail by embodiments thereof illustrated in the accompanying drawings.

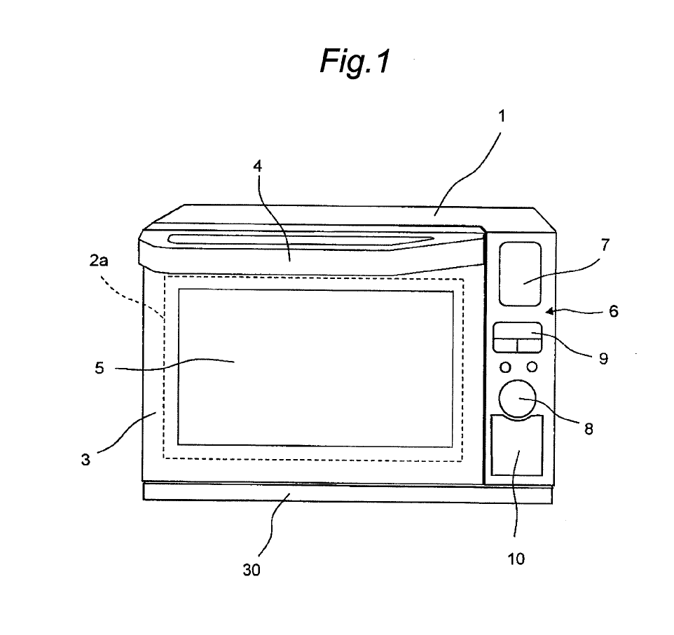

FIG. 1 is a front view of a cooking device which is an embodiment of the present invention, as viewed from its front side.

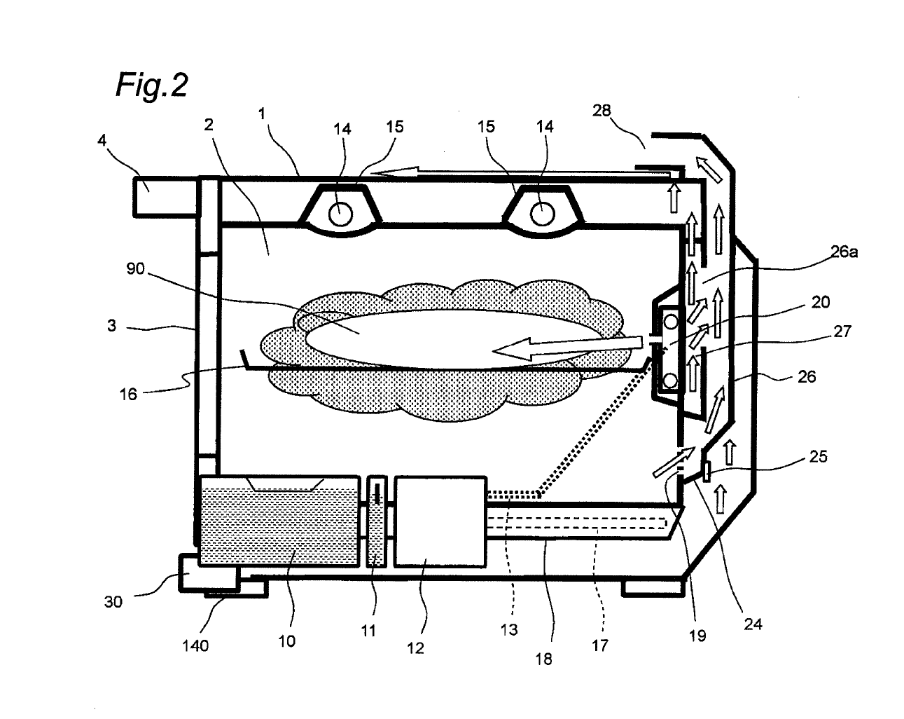

The cooking device of this embodiment, as shown in FIG. 1, includes a rectangular parallelepiped-shaped casing 1, a heating chamber 2 (shown in FIG. 2) provided in the casing 1, and an opening/closing door 3 rotatably fitted on the front side of the casing 1.

The opening/closing door 3 rotates about a lower end portion to open and close an opening 2a of the heating chamber 2. A handle 4 is attached at an upper portion of the opening/closing door 3. Also, heat-resistant glass 5 is set at a generally central portion of the opening/closing door 3, so that a user is allowed to discern an internal state of the heating chamber 2 through the heat-resistant glass 5. In the rear face of the opening/closing door 3, a packing (not shown) made of heat-resistant resin is fixedly set so as to surround the heat-resistant glass 5. When the opening/closing door 3 is closed, the packing is brought into close contact with a peripheral portion of the opening 2a of the heating chamber 2. As a result of this, leakage of steam or the like within the heating chamber 2 from between the opening/closing door 3 and the peripheral portion of the opening 2a of the heating chamber 2 can be prevented.

An operation panel 6 is provided on the right side of the front face of the casing 1. This operation panel 6 has a liquid crystal display part 7, a dial 8 and a plurality of buttons 9. Also, a water tank 10 is placed below the dial 8. This water tank 10, being fittable to and removable from the main body casing 1, is fitted to or removed from the main body casing 1 by access from the front side of the main body casing 1.

Moreover, the cooking device includes a dew receiving container 30 which is removably attached on a lower, front side of the main body casing 1 and which receives water drips dripping down along the inner surface of the opening/closing door 3 and the front face of the main body casing 1.

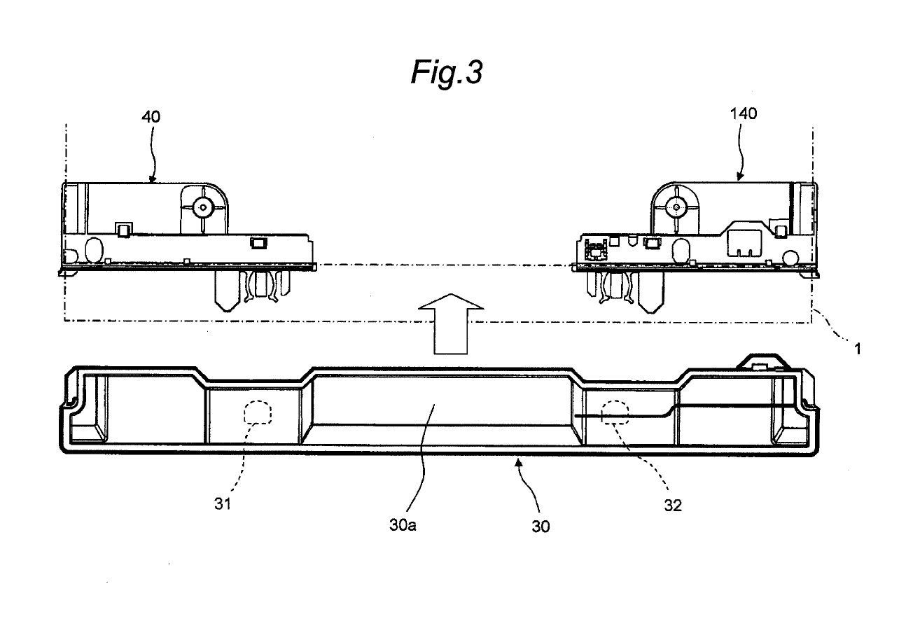

FIG. 2 is a schematic view of a longitudinal section, as viewed from a right side of the cooking device, where the same component members as in FIG. 1 are designated by the same reference signs. Reference signs in FIG. 2 denote a dew receiving container 30, a water level sensor 11, a water supply pump 12, a water supply pipe 13, an upper heater 14, an upper heater cover 15, a tray 16 for setting thereon a cooking object 90 to be cooked, a lower heater 17, a heat shielding plate 18, an exhaust port 19, an exhaust port cover 24, an exhaust thermo sensor 25, an exhaust duct 26, a cold-air inlet opening 26a, a cold-air path 27, a dilution exhaust port 28, and a steam generator 20. Although not shown, a magnetron for generating microwaves is also set in the casing 1. Further, as an example of a retention member for holding the dew receiving container 30, a left drip receiving guide 40 (see FIG. 3) and a right drip receiving guide 140 (140 only is shown in FIG. 2) are attached on the lower, front side of the main body casing 1.

The water supply pump 12 sucks water from within the water tank 10 and feeds the water via the water supply pipe 13 to the steam generator 20. This steam generator 20 is capable of heating the water derived from the water supply pump 12 to generate steam, and then supplying the generated steam to within the heating chamber 2 or superheating the steam to make it into superheated steam and supply the superheated steam into the heating chamber 2. It is noted here that the term, superheated steam, refers to steam that is heated to a superheated state of 100° C. or higher.

The cooking object 90 can be heated both by steam or superheated steam derived from the steam generator 20 and by radiation heat from the upper heater 14 and the lower heater 17. A ceiling wall of the heating chamber 2 is provided under the upper heater 14, and a bottom wall of the heating chamber 2 is provided above the lower heater 17. The upper heater 14 and the lower heater 17 are not exposed into the heating chamber 2.

FIG. 3 is a plan view showing a state before the dew receiving container 30 is fitted to the left drip receiving guide 40 and the right drip receiving guide 140 in the cooking device, as viewed from its upper side. As shown in FIG. 3, on the lower, front side of the casing 1, the left drip receiving guide 40 and the right drip receiving guide 140 as an example of the retention member are attached with a distance therebetween. With respect to the left drip receiving guide 40 and the right drip receiving guide 140, the dew receiving container 30 is moved generally horizontally from the front to the rear-face side so that the dew receiving container 30 is fitted to the left drip receiving guide 40 and the right drip receiving guide 140. In FIG. 3, reference signs 31, 32 denote a left protruding portion and a right protruding portion which are guided by the left drip receiving guide 40 and the right drip receiving guide 140, respectively.

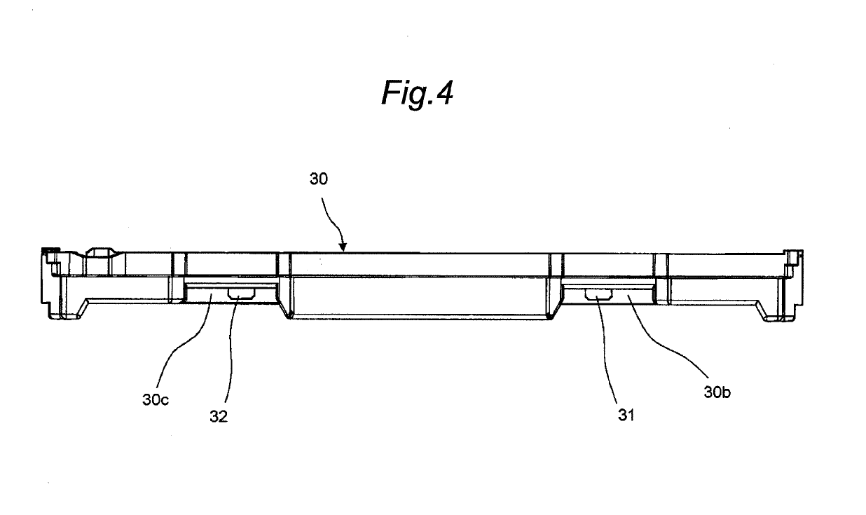

In the dew receiving container 30, as shown in the rear face view of FIG. 4, a left guide recess portion 30b and a right guide recess portion 30c are provided with a specified distance therebetween. The downwardly-protruding left protruding portion 31 is provided in the left guide recess portion 30b of the dew receiving container 30, and the downwardly-protruding right protruding portion 32 is provided in the right guide recess portion 30c.

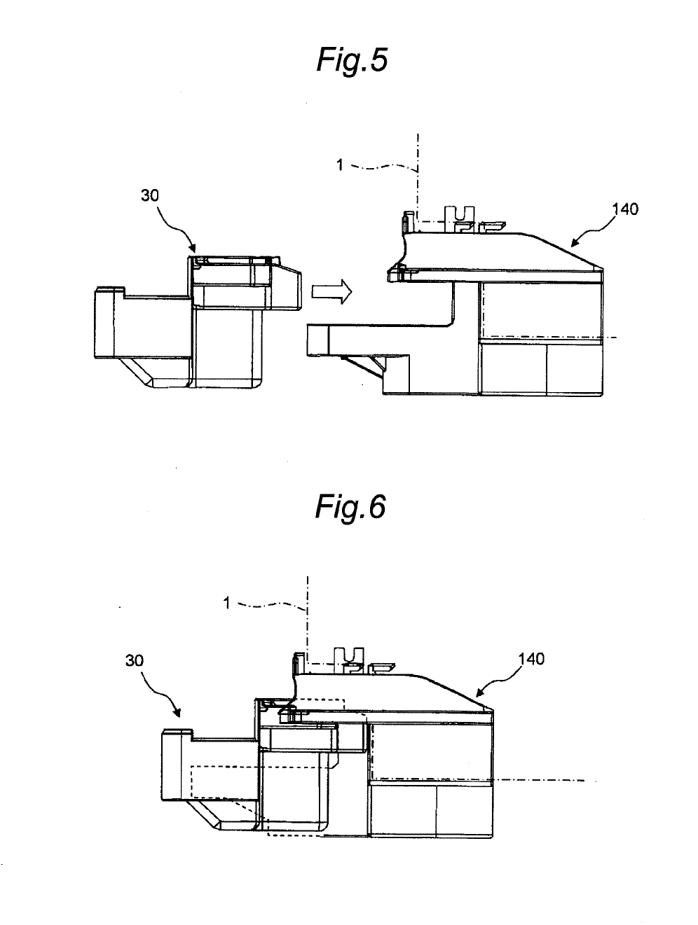

FIG. 5 is a right side view showing a state before the dew receiving container 30 is fitted to the left drip receiving guide 40 and the right drip receiving guide 140 (the right drip receiving guide 140 only is shown in FIG. 5) in the cooking device. FIG. 6 is a right side view showing a state that the dew receiving container 30 is fitted to the left drip receiving guide 40 and the right drip receiving guide 140 (the right drip receiving guide 140 only is shown in FIG. 6) in the cooking device.

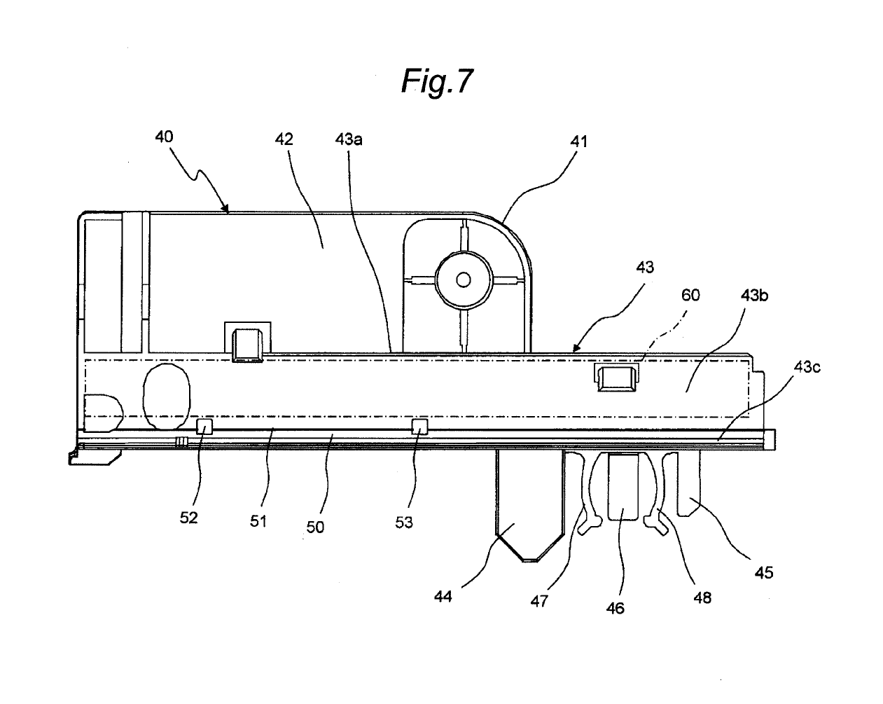

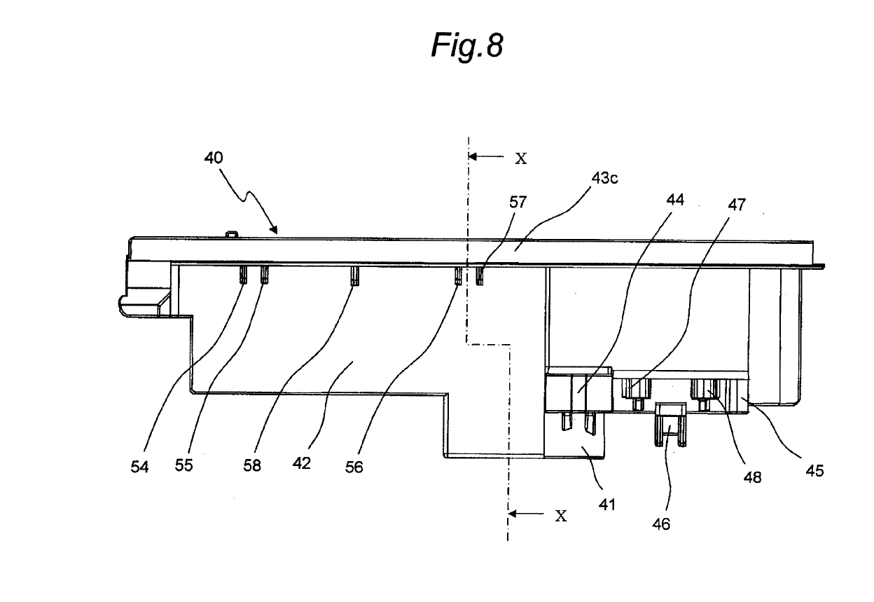

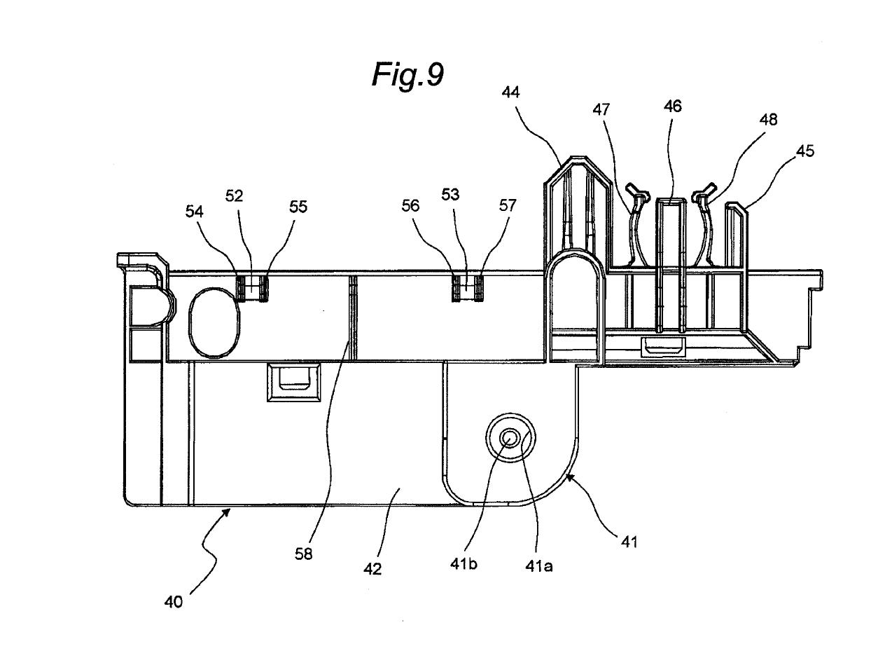

FIG. 7 is a plan view of the left drip receiving guide 40, FIG. 8 is a front view of the left drip receiving guide 40, and FIG. 9 is a bottom view of the left drip receiving guide 40.

As shown in FIGS. 7, 8 and 9, the left drip receiving guide 40 has a stand portion 41, a base portion 42 extending from the upper side of the stand portion 41 toward the left side, and a holder portion 43 provided on a front side of the stand portion 41 and the base portion 42. The holder portion 43 has a generally rectangular-shaped receiving portion 43a provided on the front side of the stand portion 41 and the base portion 42, a supporting portion 43b extending forward from an upper edge side of the receiving portion 43a to support a left lower side on the front side of the casing 1, and a bent portion 43c bent upward from a forward end side of the supporting portion 43b.

Also, on the right side of the receiving portion 43a of the holder portion 43, forward-extending insertion portion 44 and insertion portion 45 are provided with a specified distance therebetween. Between the insertion portions 44, 45 of the receiving portion 43a, an insertion portion 46 is provided so as to extend forward from a position lower than the insertion portions 44, 45, and curved arm portions 47, 48 are provided on both sides of the insertion portion 46 so as to extend from a position higher than the insertion portion 46. These curved arm portions 47, 48 pinch and hold the left protruding portion 31 of the dew receiving container 30 shown in FIGS. 3 and 4.

As shown in FIG. 7, a drainage channel 50 as an example of the recess portion is also formed in the supporting portion 43b of the holder portion 43 so as to extend along the bent portion 43c, and a rib 51 is formed along a side edge of the drainage channel 50 on one side opposite to the bent portion 43c side. Then, on one side of the supporting portion 43b opposite to the base portion 42 side, drainage holes 52, 53 partly spreading over the drainage channel 50 and partly cutting out the rib 51 are provided with a specified distance therebetween. These drainage holes 52, 53 are formed each into a generally square shape as an example of the rectangular shape. Further, a seal member 60 is set on the upper surface of the supporting portion 43b so as not to cover the drainage channel 50 and the drainage holes 52, 53.

As shown in FIGS. 8 and 9, ribs 54, 55 as an example of the downward-extending drip downward-drawing member are provided on left-and-right opposing two side lines of the drainage hole 52, while ribs 56, 57 as an example of the downward-extending drip downward-drawing member are provided on left-and-right opposing two side lines of the drainage hole 53. The ribs 54, 55 are located near an opening rim of the drainage hole 52, while the ribs 56, 57 are located near an opening rim of the drainage hole 53. Also, a downward-extending reinforcing rib 58 is provided on the lower side of the supporting portion 43b and between the drainage holes 52, 53. Further, as shown in FIG. 9, a columnar-shaped hole 41a and a through hole 41b in upper part of the hole 41a are provided in the stand portion 41. A screw (not shown) is screwed into the through hole 41b from below so as to be screwed with the lower face of the upper-side main body casing 1, by which the left drip receiving guide 40 is fixed to the front-face side, left-lower side of the casing 1.

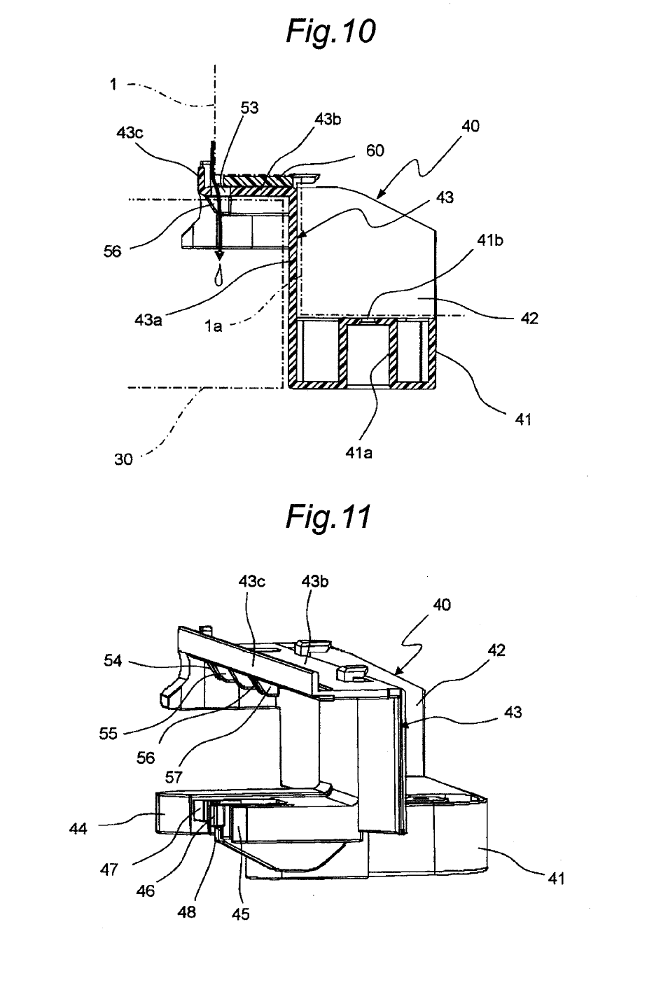

FIG. 10 is a sectional view of the left drip receiving guide 40 taken along the line X-X shown in FIG. 8, and FIG. 11 is a perspective view of the left drip receiving guide 40 as viewed from a diagonal upward in the front, where the same component members as in FIGS. 7 to 9 are designated by the same reference signs. As shown in FIG. 10, on the lower, front side of the main body casing 1, a housing step portion 1a is formed so that part of the dew receiving container 30 is located in the rear side from the front face of the main body casing 1. The seal member 60 is set between the main body casing 1 and the top face of the supporting portion 43b of the left drip receiving guide 40. In this case, the front face of the main body casing 1 is located upward between the front face of the seal member 60 and the bent portion 43c.

Then, drips that drip along the front face of the main body casing 1 to between the front face of the seal member 60 and the bent portion 43c are received by the drainage channel 50 (shown in FIG. 7) and thereafter led to the lower dew receiving container 30 by the drainage holes 52, 53 and the ribs 54-57.

The ribs 54-57 of the left drip receiving guide 40 are formed each into a downward-tapered shape as shown in FIGS. 10 and 11.

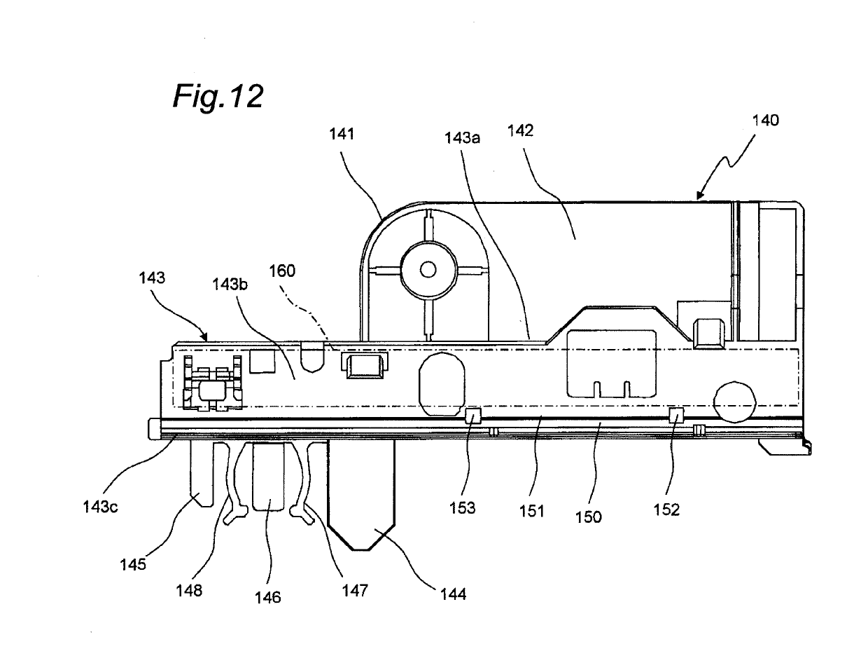

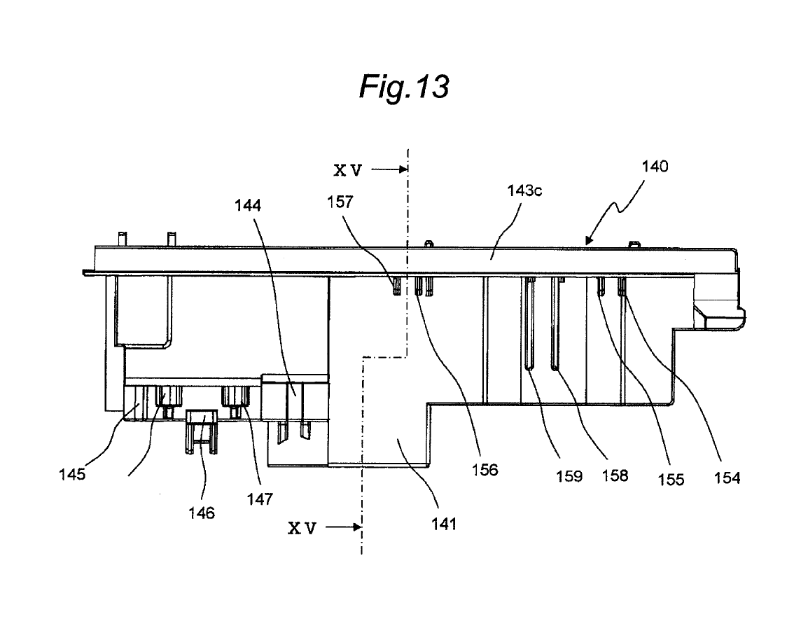

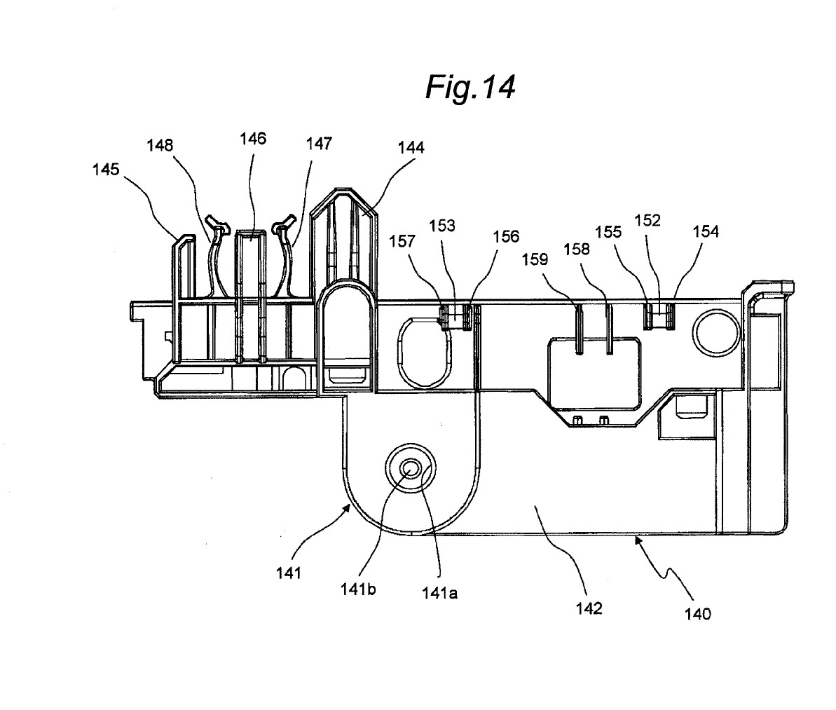

FIG. 12 is a plan view of the right drip receiving guide 140, FIG. 13 is a front view of the right drip receiving guide 140, and FIG. 14 is a bottom view of the right drip receiving guide 140.

As shown in FIGS. 12, 13 and 14, the right drip receiving guide 140 has a stand portion 141, a base portion 142 extending from the upper side of the stand portion 41 toward the right side, and a holder portion 143 provided on a front side of the stand portion 141 and the base portion 142. The holder portion 143 has a generally rectangular-shaped receiving portion 143a provided on the front side of the stand portion 141 and the base portion 142, a supporting portion 143b extending forward from an upper edge side of the receiving portion 143a to support a right lower side on the front side of the casing 1, and a bent portion 143c bent upward from a forward end side of the supporting portion 143b.

Also, on the left side of the receiving portion 143a of the holder portion 143, forward-extending insertion portion 144 and insertion portion 145 are provided with a specified distance therebetween. Between the insertion portions 144, 145 of the receiving portion 143a, an insertion portion 146 is provided so as to extend forward from a position lower than the insertion portions 144, 145, and curved arm portions 147, 148 are provided on both sides of the insertion portion 146 so as to extend from a position higher than the insertion portion 146. These curved arm portions 147, 148 pinch and hold the right protruding portion 32 of the dew receiving container 30 shown in FIGS. 3 and 4.

As shown in FIG. 12, a drainage channel 150 as an example of the recess portion is also formed in the supporting portion 143b of the receiving portion 143a of the holder portion 143 so as to extend along the bent portion 143c, and a rib 151 is formed along a side edge of the drainage channel 150 on one side opposite to the bent portion 143c side. Then, on one side of the supporting portion 143b opposite to the base portion 142 side, drainage holes 152, 153 partly spreading over the drainage channel 150 and partly cutting out the rib 151 are provided with a specified distance therebetween. These drainage holes 152, 153 are formed each into a generally square shape as an example of the rectangular shape. Further, a seal member 160 is set on the upper surface of the supporting portion 143b so as not to cover the drainage channel 150 and the drainage holes 152, 153.

As shown in FIGS. 13 and 14, downward-extending ribs 154, 155 are provided on left-and-right opposing two side lines of the drainage hole 152, while downward-extending ribs 156, 157 are provided on left-and-right opposing two side lines of the drainage hole 153. Also, downward-extending reinforcing ribs 158, 159 are provided on the lower side of the supporting portion 143b and between the drainage holes 152, 153. Further, as shown in FIG. 14, a columnar-shaped hole 141a and a through hole 141b in upper part of the hole 141a are provided in the stand portion 141. A screw (not shown) is screwed into the through hole 141b from below so as to be screwed with the lower face of the upper-side main body casing 1, by which the right drip receiving guide 140 is fixed to the front-face side, right-lower side of the casing 1.

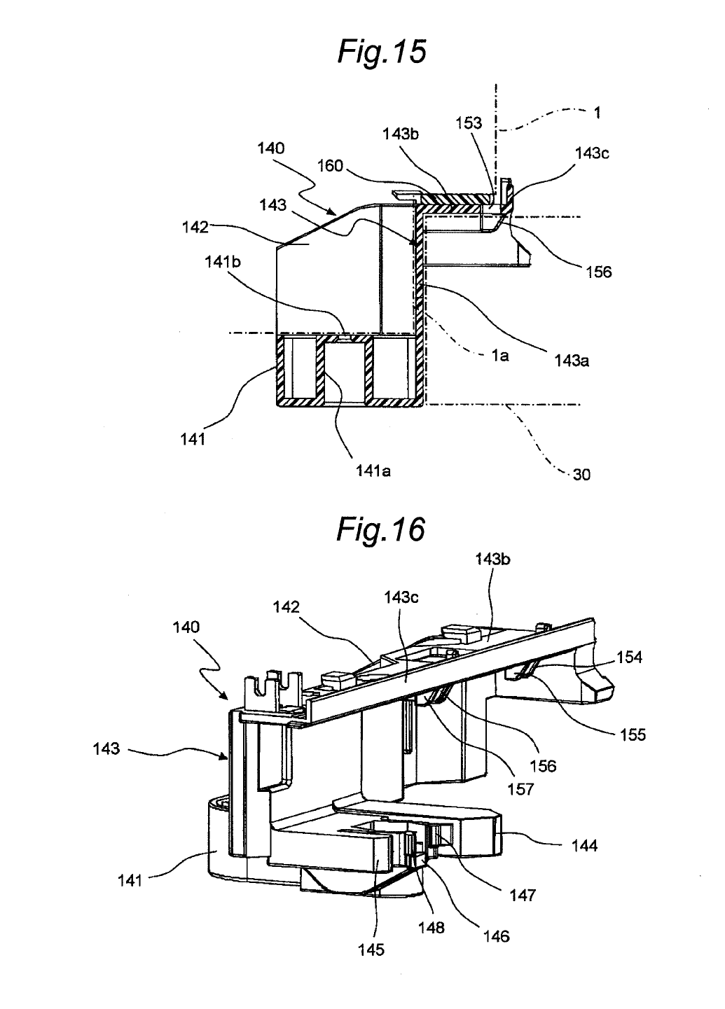

FIG. 15 is a sectional view of the right drip receiving guide 140 taken along the line XV-XV shown in FIG. 13, and FIG. 16 is a perspective view of the right drip receiving guide 140 as viewed from a diagonal upward in the front, where the same component members as in FIGS. 12 to 14 are designated by the same reference signs. As shown in FIG. 15, on the lower, front side of the main body casing 1, a housing step portion 1a is formed so that part of the dew receiving container 30 is located in the rear side from the front face of the main body casing 1. The seal member 160 is set between the main body casing 1 and the top face of the supporting portion 143b of the right drip receiving guide 140. In this case, the front face of the main body casing 1 is located upward between the front face of the seal member 160 and the bent portion 143c.

Then, drips that drip along the front face of the main body casing 1 to between the front face of the seal member 160 and the bent portion 143c are received by the drainage channel 150 (shown in FIG. 12) and thereafter led to the lower dew receiving container 30 by the drainage holes 152, 153 and the ribs 154-157.

The ribs 154-157 of the right drip receiving guide 140 are formed each into a downward-tapered shape as shown in FIGS. 15 and 16.

In the cooking device constructed as described above, the dew receiving container 30 is removably attached to the main body casing 1 by the left drip receiving guide 40 and the right drip receiving guide 140 provided on the lower, front side of the main body casing 1. Drips that drip along the front face of the main body casing 1 are received by the drainage channels 50, 150 of the left drip receiving guide 40 and the right drip receiving guide 140 provided on a dew receiving recessed portion 30a of the dew receiving container 30. Then, drips received by the drainage channels 50, 150 are led to the dew receiving recessed portion 30a of the lower dew receiving container 30 by the drainage holes 52, 53, 152, 153. In this case, the drips are drawn downward by the ribs 54-55, 154-157, which are the drip downward-drawing members provided near the opening rims of the drainage holes 52, 53, 152, 153 of the left drip receiving guide 40 and the right drip receiving guide 140, so that the drips are led from the drainage holes 52, 53, 152, 153 to the dew receiving container 30. As a result, drips that have accumulated in upper parts of the left drip receiving guide 40 and the right drip receiving guide 140 for the dew receiving container 30 can be drained smoothly to the lower dew receiving container 30.

Also, by the rib-shaped drip downward-drawing member 54-57, 154-157, drips are led from the drainage holes 52, 53, 152, 153 of the left drip receiving guide 40 and the right drip receiving guide 140 along the drip downward-drawing members toward the lower dew receiving container 30, so that the drips accumulated in upper parts of the left drip receiving guide 40 and the right drip receiving guide 140 can be drained smoothly to the lower dew receiving container 30.

With the drainage holes 52, 53, 152, 153 formed each into a shape having an angle defined by straight lines at an inner edge, when drips received by the drainage channels 50, 150 of the left drip receiving guide 40 and the right drip receiving guide 140 are led to the dew receiving recessed portion 30a of the lower dew receiving container 30 by the drainage holes 52, 53, 152, 153, surface tension of the drips is dispersed by the angles (angles defined by straight lines) at the inner edges of the drainage holes 52, 53, 152, 153, inhibiting rounding of the drips, so that the drips are prevented from being rounded by surface tension and staying at the drainage holes 52, 53, 152, 153, and are led from the drainage holes 52, 53, 152, 153 to the lower dew receiving container 30. Accordingly, drips accumulated in upper parts of the left drip receiving guide 40 and the right drip receiving guide 140 for the dew receiving container 30 can be drained more smoothly to the lower dew receiving container. In this case, the shape of each drainage hole has only to be one having at least one angle defined by straight lines at the inner edge, and is not limited to a rectangular or other shape.

Also, with the drainage holes 52, 53, 152, 153 of the left drip receiving guide 40 and the right drip receiving guide 140 formed each into a rectangular shape, providing four such angles as defined by straight lines at the inner edges of the drainage holes 52, 53, 152, 153 makes it possible to reliably prevent the drips from being rounded by surface tension.

Also, with downward-extending ribs 54-57, 154-157 provided at opposing two side lines, respectively, of the drainage holes 52, 53, 152, 153 of the left drip receiving guide 40 and the right drip receiving guide 140, drips are led from the opposing two side lines of the drainage holes 52, 53, 152, 153 to the dew receiving container 30 along the ribs 54-57, 154-157, so that drips accumulated in upper parts of the left drip receiving guide 40 and the right drip receiving guide 140 can be drained more smoothly to the lower dew receiving container 30. Besides, the strength of the left drip receiving guide 40 and the right drip receiving guide 140 can be improved by the ribs 54-57, 154-157.

Also, with the ribs 54-57, 154-157 formed each into a downward-tapered shape, drips led from the drainage holes 52, 53, 152, 153 along the ribs 54-57, 154-157 toward the lower dew receiving container 30 are more easily dripped from lower ends of the ribs 54-57, 154-157 to the lower dew receiving container 30, so that a smooth drainage can be realized.

In this embodiment, the downward-extending ribs 54-57, 154-157 are provided on the opposing two side lines of the rectangular-shaped drainage holes 52, 53, 152, 153 as a drip downward-drawing member of the left drip receiving guide 40 and the right drip receiving guide 140 as a retention member. However, the ribs of the retention member may also be provided on at least one side line of each rectangular-shaped drainage hole.

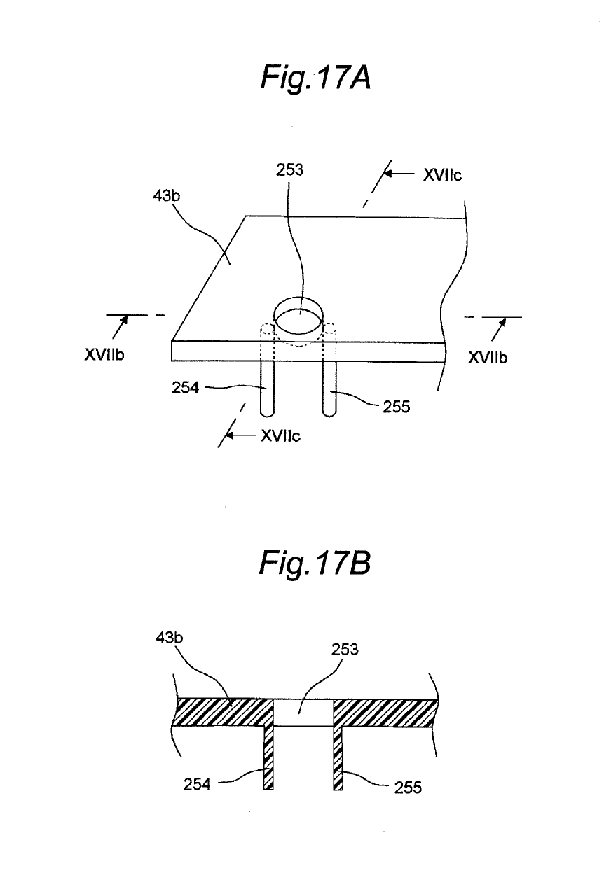

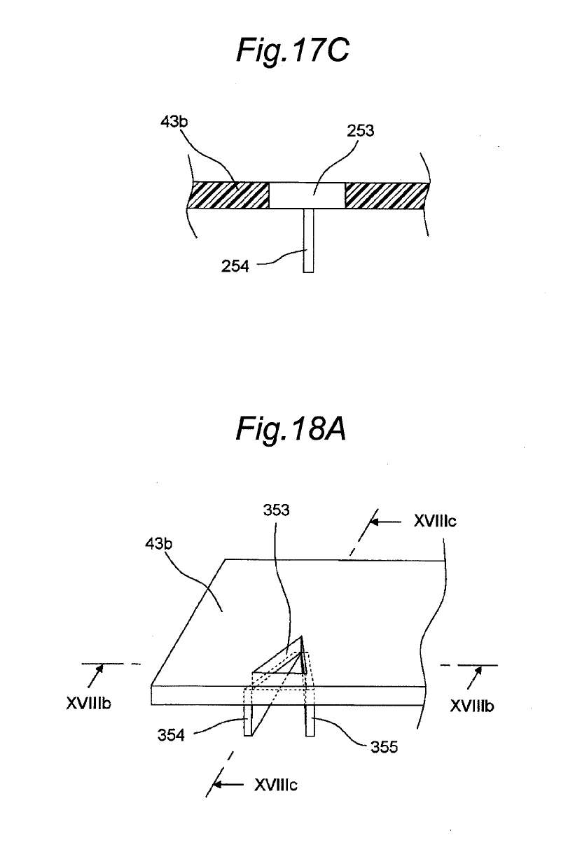

Also, the drainage holes and the drip downward-drawing member are not limited to those of the above-described embodiment, and may appropriately be set according to the shape of the retention member or the like, for example, set as first to third examples shown in FIGS. 17A-17C, 18A-18C and 19A-19C. It is noted that in FIGS. 17A-17C, 18A-18C and 19A-19C, the supporting portion 43b of the holder portion 43 (shown in FIGS. 7, 8 and 9) is simplified for an easier view.

FIG. 17A is a perspective view of a drainage hole and drip downward-drawing members in the first example, FIG. 17B is a sectional view taken along the line XVIIb-XVIIb of FIG. 17A, and FIG. 17C is a sectional view taken along the line XVIIc-XVIIc of FIG. 17A.

As shown in FIGS. 17A-17C, a circular-shaped drainage hole 253 is provided in the supporting portion 43b of the holder portion 43 (shown in FIGS. 7, 8, 9). Besides, downward-extending, rod-shaped drip downward-drawing members 254, 255 are provided near an opening rim of the drainage hole 253.

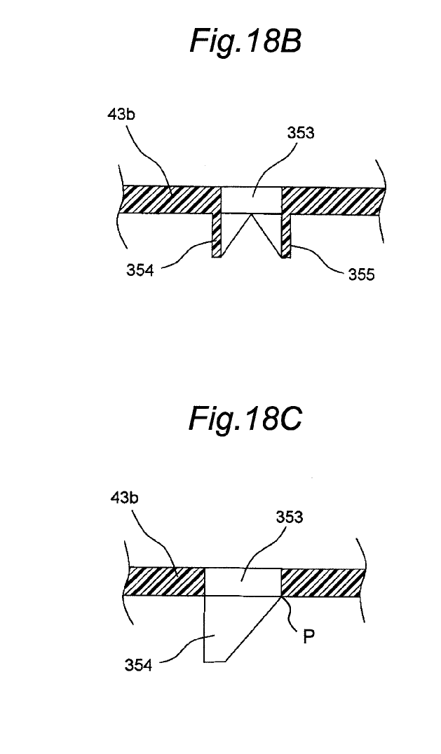

FIG. 18A is a perspective view of a drainage hole and ribs as a drip downward-drawing member in the second example, FIG. 18B is a sectional view taken along the line XVIIIb-XVIIIb of FIG. 18A, and FIG. 180 is a sectional view taken along the line XVIIIc-XVIIIc of FIG. 18A.

As shown in FIGS. 18A-18C, an isosceles triangle-shaped drainage hole 353 is provided in the supporting portion 43b of the holder portion 43 (shown in FIGS. 7, 8, 9). Besides, trapezoidal-shaped ribs 354, 355 as an example of downward-extending drip downward-drawing members are provided near an opening rim and on neighboring two sides of the drainage hole 353. As shown in FIG. 18C, one rib 354 is formed into a trapezoidal shape which is tapered downward from one side of the triangular-shaped drainage hole 353, the one side adjoining to a point P located on an apical-angle side of the opening of the drainage hole 353. The rib 354 has opposing two parallel bases on the opening side and the lower end side, has a side extending downward vertically from one end (base angle side) opposite to the point P of the opening-side base, and moreover has a side sloping downward from the point P side of the opening-side base. In contrast to this, shape and placement of the other rib 355 are right-and-left symmetrical with respect to a center line through which the opening vertex P of the drainage hole 353.

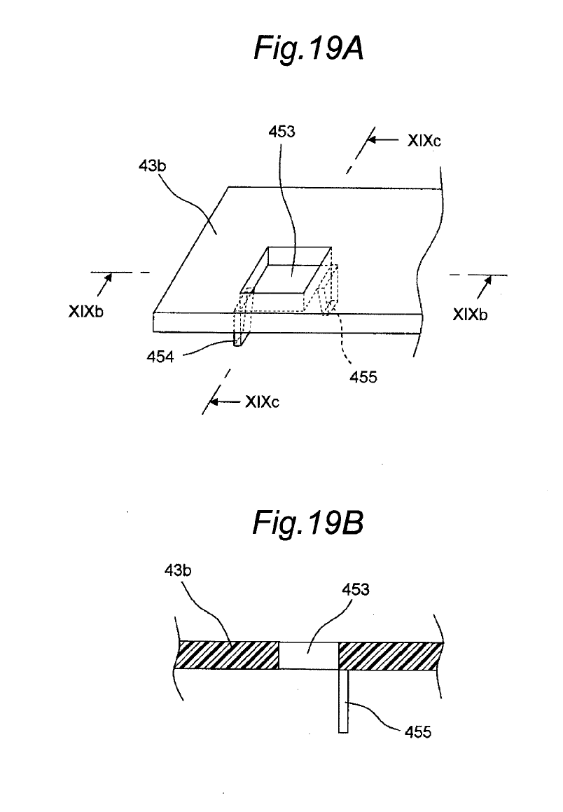

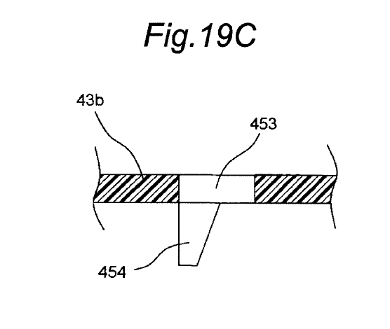

FIG. 19A is a perspective view of a drainage hole and a rib as a drip downward-drawing member in the third example, FIG. 19B is a sectional view taken along the line XIXb-XIXb of FIG. 19A, and FIG. 19C is a sectional view taken along the line XIXc-XIXc of FIG. 19A.

As shown in FIGS. 19A-19C, a rectangular-shaped drainage hole 453 is provided in the supporting portion 43b of the holder portion 43 (shown in FIGS. 7, 8, 9). Besides, trapezoidal-shaped ribs 454, 455 as an example of downward-extending, drip downward-drawing members are provided near an opening rim and on opposing two sides of the drainage hole 453. As shown in FIG. 19C, one rib 454 is formed into a downward-tapered trapezoidal shape. The rib 454 has opposing two parallel bases on the opening side and the lower end side, has a side extending downward vertically from one end of the opening-side base (a corner portion of the opening of the rectangular-shaped drainage hole 453), and moreover has a side sloping downward from the other end of the opening-side base (a central portion of one side of the opening of the rectangular-shaped drainage hole 453). In contrast to this, shape and placement of the other rib 455 are point symmetrical with respect to a center of the opening of the drainage hole 453.

Any of the embodiment and the first to third examples shown above has been described on drip downward-drawing members which are provided on the near-to-rim, lower side of the opening of the drainage hole and which extend downward. However, without being limited to this, a drip downward-drawing member may be provided on a near-to-rim, upper side of the opening of the drainage hole, or drip downward-drawing members may be provided on near-to-rim, both upper and lower sides of the opening of the drainage hole. Moreover, another drip downward-drawing member may be provided on the near-to-rim, upper side of the opening of the drainage hole so as to adjoin a drip downward-drawing member extending downward from the near-to-rim, lower side of the opening of the drainage hole.

In the cooking device of this invention, the shape of the drainage hole of the retention member or the shape of the drip downward-drawing member may be provided in various forms and, moreover, appropriately combined from among a plurality of forms.

In the above embodiment, the opening 2a of the heating chamber 2 is opened and closed by the pivotal-type opening/closing door 3. However, the opening of the heating chamber may also be opened and closed by, for example, an opening/closing door that slides in back-and-forth directions with respect to the main body casing 1. That is, the opening/closing door included in the cooking device of the invention may be either pivotal type or slide type.

The cooking device of this invention is exemplified by not only microwave ovens using superheated steam, but also ovens using superheated steam, microwave ovens using no superheated steam, ovens using no superheated steam, and the like.

The cooking device of this invention makes it possible to achieve healthy cooking by using superheated steam or saturated steam in ovens, microwave ovens or the like. For example, in a cooking device of the invention, superheated steam or saturated steam of 100° C. or higher temperatures is supplied to food surfaces, so that superheated steam or saturated steam in contact with the food surfaces is condensed to give large amounts of condensed latent heat to foods, thus making it possible to achieve an efficient transfer of heat to foods. Also, condensed water is attached to food surfaces, and salinity or oil contents drip together with the condensed water, so that salinity or oil contents in foods can be reduced. Furthermore, the heating box is internally filled with superheated steam or saturated steam so as to come into an absence-of-oxygen state, thus making it possible to do food oxidation-suppressed cooking.

Also, the cooking device of this invention may comprise:

a main body casing;

a heating chamber placed within the main body casing and being for heating a heating object to be heated;

a steam generator placed within the main body casing and being for generating steam to be supplied to the heating chamber;

a door placed on a front side of the main body casing and being for opening and closing an opening of the heating chamber;

a dew receiving container removably attached on a lower, front side of the main body casing; and

a retention member provided on the lower, front side of the main body casing and being for holding the dew receiving container, wherein

the retention member has a recess portion which is provided on a dew receiving recessed portion of the dew receiving container and which receives drips dripping down along a front face of the main body casing, and a drainage hole for leading the drips received by the recess portion to the lower dew receiving recessed portion, and

the drainage hole of the retention member has, at an inner edge thereof, an angle formed by intersecting straight lines.

It is noted here that the shape of a drainage hole having, at an inner edge thereof, an angle formed by intersecting straight lines has only to have, at its inner edge, at least one angle formed by intersecting straight lines, and the shape is not limited to rectangular sharps or the like.

With the construction described above, the dew receiving container is removably attached by the retention member provided on the lower, front side of the main body casing. Drips dripping down along the front face of the main body casing are received by the recess portion of the retention member provided on the dew receiving recessed portion of the dew receiving container. Then, the drips received by the recess portion are led to the dew receiving recessed portion of the lower dew receiving container by the drainage hole. In this process, the shape of the drainage hole of the retention member, which is formed into a shape having, at an inner edge, an angle formed by intersecting straight lines, causes the surface tension of drips to be dispersed by the angle of intersecting straight lines at the inner edge of the drainage hole, inhibiting rounding of the drips, so that the drips are prevented from being rounded by surface tension and staying at the drainage hole, and are led from the drainage holes to the lower dew receiving container. Accordingly, drips accumulated in upper part of the retention member for the dew receiving container can be drained smoothly to the lower dew receiving container.

In the cooking device of one embodiment, the drainage hole of the retention member is formed into a rectangular shape.

According to this embodiment, the drainage hole of the retention member is formed into a rectangular shape, and the angle of intersecting straight lines is provided at four places of the inner edge of the drainage hole. Thus, water drips can be prevented from being rounded by surface tension more reliably.

In the cooking device of one embodiment, a downward-extending rib is provided at least one side line of the rectangular-shaped drainage hole of the retention member.

According to this embodiment, by the downward-extending rib provided at least one side line of the rectangular-shaped drainage hole of the retention member, drips are led from the drainage hole toward the lower dew receiving container along the rib. Accordingly, drips accumulated in upper part of the retention member can be drained more smoothly to the lower dew receiving container.

In the cooking device of one embodiment, downward-extending ribs are provided on opposing two side lines, respectively, of the rectangular-shaped drainage hole of the retention member.

According to this embodiment, by the downward-extending ribs provided on opposing two side lines, respectively, of the rectangular-shaped drainage hole of the retention member, drips are led from the opposing two side lines of the drainage hole along the ribs toward the lower dew receiving container. Accordingly, drips accumulated in upper part of the retention member can be drained more smoothly to the lower dew receiving container.

In the cooking device of one embodiment, the ribs are formed each into a downward-tapered shape.

According to this embodiment, by the ribs formed into a downward-tapered shape, drips led from the drainage hole along the ribs toward the lower dew receiving container are more easily dripped from lower ends of the ribs to the lower dew receiving container. Thus, it becomes possible to fulfill smooth drainage.

### REFERENCE SIGNS LIST

1 main body casing
1a housing step portion
2 heating chamber
2a opening
3 opening/closing door
4 handle
5 heat-resistant glass
6 operation panel
7 liquid crystal display part
8 dial
9 button
10 water tank
30 dew receiving container
30b left guide recess portion
30c right guide recess portion
31 left protruding portion
32 right protruding portion
40 left drip receiving guide
50 drainage channel
52, 53 drainage hole
54-57 rib
90 cooking object
140 right drip receiving guide
150 drainage channel
152, 153 drainage hole
154-157 rib
253 drainage hole
254, 255 drip downward-drawing member
353 drainage hole
354, 355 rib
453 drainage hole
454, 455 rib

1. A cooking device comprising:
a main body casing;
a heating chamber placed within the main body casing and being for heating a heating object to be heated;
a steam generator placed within the main body casing and being for generating steam to be supplied to the heating chamber;
a door placed on a front side of the main body casing and being for opening and closing an opening of the heating chamber;
a dew receiving container removably attached to a lower, front side of the main body casing; and
a retention member provided on the lower, front side of the main body casing and being for holding the dew receiving container, wherein
the retention member has
a recess portion which is provided on a dew receiving recessed portion of the dew receiving container and which receives drips dripping down along a front face of the main body casing, and
a drainage hole for leading the drips received by the recess portion to the lower dew receiving recessed portion, and
a drip downward-drawing member provided near an opening edge of the drainage hole of the retention member.

2. The cooking device as claimed in claim 1, wherein
the drip downward-drawing member is at least rib- or rod-shaped.

3. The cooking device as claimed in claim 1, wherein
the drainage hole of the retention member has, at an inner edge thereof, an angle defined by straight lines.

4. The cooking device as claimed in claim 3, wherein
the drainage hole of the retention member is formed into a rectangular shape.

5. The cooking device as claimed in claim 1, wherein
the drip downward-drawing member is formed into a downward-tapered shape.

6. The cooking device as claimed in claim 2, wherein
the drainage hole of the retention member has, at an inner edge thereof, an angle defined by straight lines.

7. The cooking device as claimed in claim 2, wherein
the drip downward-drawing member is formed into a downward-tapered shape.

8. The cooking device as claimed in claim 3, wherein
the drip downward-drawing member is formed into a downward-tapered shape.

9. The cooking device as claimed in claim 4, wherein
the drip downward-drawing member is formed into a downward-tapered shape.

10. The cooking device as claimed in claim 6, wherein
the drip downward-drawing member is formed into a downward-tapered shape.
